(19) United States
(12) Patent Application Publication
(10) Pub. No.: US 2013/0339083 A1
(43) Pub. Date: Dec. 19, 2013

(54) PRODUCT PLACEMENT IN RETAIL SETTINGS

(71) Applicants: Mark Walter Baier, Lakeville, MN (US); Harpreet Kaur, New Delhi (IN); Sriram TE, Chennai (IN); Kristin Anne Storrs, Blaine, MN (US); Alyssa Donna Simmons, Plymouth, MN (US)

(72) Inventors: Mark Walter Baier, Lakeville, MN (US); Harpreet Kaur, New Delhi (IN); Sriram TE, Chennai (IN); Kristin Anne Storrs, Blaine, MN (US); Alyssa Donna Simmons, Plymouth, MN (US)

(73) Assignee: TARGET BRANDS, INC., Minneapolis, MN (US)

(21) Appl. No.: 13/495,968

(22) Filed: Jun. 13, 2012

(51) Int. Cl. G06Q 30/02

(52) U.S. Cl. 705/7.29

(57) ABSTRACT

Products are selected for placement on check-out lane end caps at retail store locations. In one example, products are selected for placement on check-out lane end caps in one or more stores based on historical sales data for each product across all of the stores. Each check-out lane end cap includes a fixture configured to hold and display product(s) for sale in a store. A total number of stores into which each product is to be placed in at least one check-out lane end cap is received. A sales performance metric is determined for each selected product based on in-store historical sales data representative of sales of the product in each store. A particular store into which to place each selected product in a check-out lane end cap is determined based on the received total number of stores and the determined sales performance metric for the product.

### TECHNICAL FIELD

This disclosure generally relates to techniques for product placement in retail settings, and more specifically, to techniques for placement of products in particular locations within retail store locations.

### BACKGROUND

Consumers may purchase various products via retail stores. More specifically, retail stores may represent the final point of sale (“POS”) before an end-user gains possession of a product. To this end, retail stores may stock and sell a wide variety of products, and may cater to large customer demands. For example, several modern retail stores cover areas exceeding 120,000 square feet (11,148 square meters). Larger versions of these retail stores, such as so-called “super stores,” may cover areas exceeding 170,000 square feet (or 15,793 square meters). As retail stores gain area and variety of products that they carry, the placement and arrangement of products within a retail store is becoming a more relevant, complex, and intricate inquiry.

### SUMMARY

This disclosure relates to techniques for selecting products to place on check-out lane end caps at retail store locations. Additionally, the techniques may enable allocation of the selected products across various stores and end caps within each store. In various examples, one or more vendors (e.g., manufacturers, wholesalers, etc.) may submit a product or a suite of products (or “program”) to a retail chain for placement on check-out lane end caps at one or more store locations. A retail chain may be a business entity that controls or otherwise operates multiple retail store locations. In a business setting, the retail chain may operate the store locations through a variety of plans, such as direct ownership, franchising, licensing, subsidiary stakes, and others. In many retail scenarios, check-out lane end caps may represent sought-after areas, as customers may be more likely to make impulse purchases immediately prior to check-out. However, retail store locations may include a limited number of check-out lane end caps, and the available end caps may not be sufficient to accommodate all of the products and programs submitted by vendors for end cap placement.

Examples according to this disclosure may function to allocate a number of product programs from an eligible pool of programs to particular store locations such that the allocation results in improved sales performance of the programs for a given time period, e.g., for a season. The examples disclosed may function to improve sales performance by employing an optimization algorithm(s) configured to optimize the placement of the product programs in particular end caps within particular store locations for a particular sales metric(s), e.g. sales revenue, profit, or the volume of units. Additionally, the end cap optimization techniques included in the disclosed examples may be subject to a number of constraints, including, e.g., the total number of stores into which each product program is required to be placed, the number of end caps in each store and the end cap priority level of each end cap, and the end cap priority level assigned to each program.

Examples according to this disclosure may provide various advantages. In general, systems and methods according to this disclosure may improve sales and/or profits by optimizing the placement of various product programs on check-out lane end caps of a number of store locations. In one example method, products are selected to be placed in check-out lane end caps in a plurality of stores based on historical sales data for each of the products across all of the stores. Each of the check-out lane end caps includes a fixture configured to hold and display one or more products for sale in a store. The method also includes receiving a total number of stores into which each of the products is to be placed in at least one check-out lane end cap and determining, with a computing device, a sales performance metric for each of the selected products based at least in part on in-store historical sales data representative of sales of the product in each of the plurality of stores. Additionally, a particular store into which to place each of the selected products in a check-out lane end cap of that store is determined based at least in part on the received total number of stores into which the product is to be placed and the determined sales performance metric for the product.

In another example, a device includes a computer readable storage memory and at least one processor configured to access information stored on the computer readable storage medium. The at least one processor is configured to perform operations including selecting a plurality of products to be placed in a plurality of check-out lane end caps in a plurality of stores based at least in part on historical sales data for each of the plurality of products across all of the plurality of stores, in which each of the plurality of check-out lane end caps comprises a fixture configured to hold and display one or more products for sale in a store, receiving a total number of stores into which each of the selected products is to be placed in at least one check-out lane end cap, determining, with a computing device, a sales performance metric for each of the selected products based at least in part on in-store historical sales data representative of sales of the product in each of the plurality of stores, and determining, with the computing device, which of the plurality of stores to place each of the selected products in a check-out lane end cap of that store based at least in part on the received total number of stores into which the product is to be placed and the determined sales performance metric for the product.

Another example includes a computer-readable storage device encoded with instructions that, when executed, cause one or more processors of a computing device to select a plurality of products to be placed in a plurality of check-out lane end caps in a plurality of stores based at least in part on historical sales data for each of the plurality of products across all of the plurality of stores, in which each of the plurality of check-out lane end caps comprises a fixture configured to hold and display one or more products for sale in a store, receive a total number of stores into which each of the selected products is to be placed in at least one check-out lane end cap, determine a sales performance metric for each of the selected products based at least in part on in-store historical sales data representative of sales of the product in each of the plurality of stores, and determine which of the plurality of stores to place each of the selected products in a check-out lane end cap of that store based at least in part on the received total number of stores into which the product is to be placed and the determined sales performance metric for the product.

The details of one or more examples of the disclosure are set forth in the accompanying drawings and the description below. Other features, objects, and advantages of examples according to this disclosure will be apparent from the description and drawings, and from the claims.

### BRIEF DESCRIPTION OF DRAWINGS

FIG. 1 is a conceptual diagram illustrating a customer check-out area that includes check-out lanes with end caps at a retail store location.

FIG. 2 is a conceptual diagram illustrating an example system for performing end cap optimization, in accordance with one or more aspects of this disclosure.

FIG. 3 is a block diagram illustrating an example end cap optimization engine.

FIG. 4 is a block diagram illustrating details of an example computing device that may implement end cap optimization techniques, in accordance with one or more aspects of this disclosure.

FIG. 5 is a flowchart illustrating an example process that a computing device may perform to implement end cap optimization, in accordance with one or more aspects of this disclosure.

### DETAILED DESCRIPTION

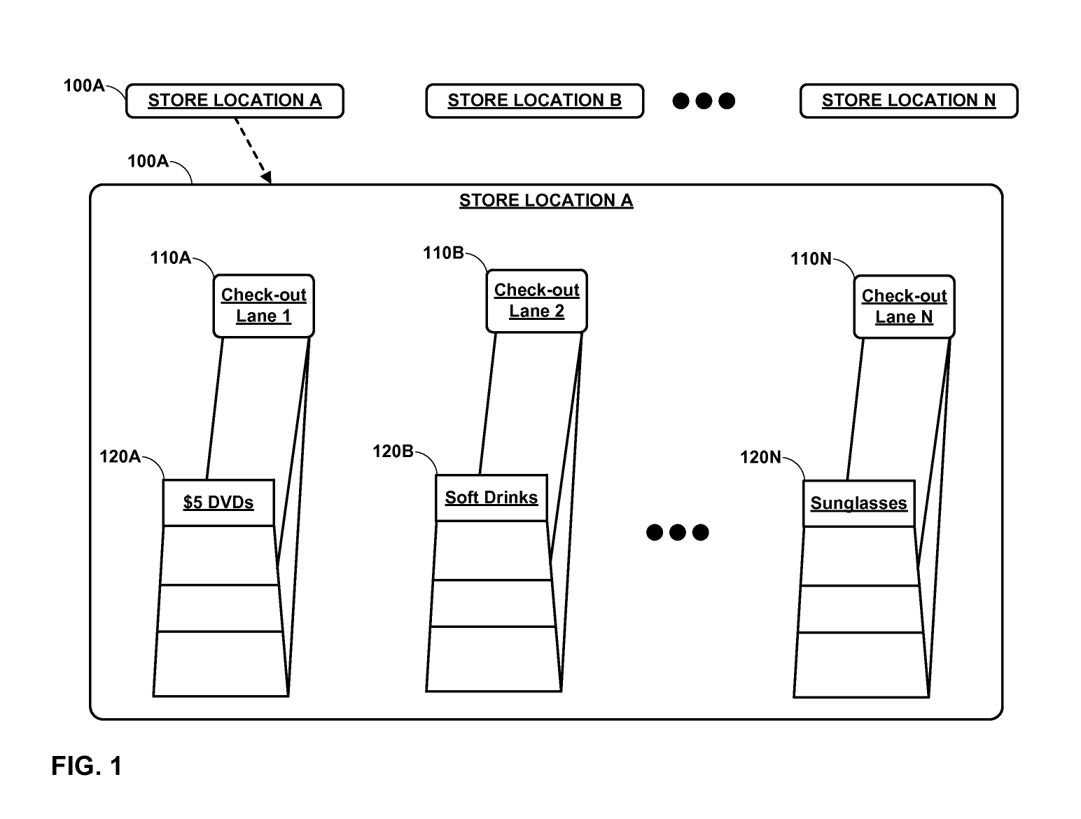

FIG. 1 is a conceptual diagram illustrating a customer check-out area that includes check-out lanes 110A-110C with respective end caps 120A-120C at a retail store location 100A. As shown in FIG. 1, retail store location 100A may be one of a plurality of retail store locations 100A-100N. For purposes of clarity only, FIG. 1 will be described with respect to retail store location 100A, though it will be appreciated that the techniques of this disclosure may apply to one or more of retail store locations 100A-100N, alone or in any combination. Certain details of store location 100A, such as a check-out area, are illustrated in FIG. 1. More specifically, the check-out area of store location 100A includes check-out lanes 110A-110N (collectively, “check-out lanes 110”). Each of check-out lanes 100 is associated with a corresponding fixture known as an end cap. In the example of FIG. 1, each of check-out lanes 100A-100N is associated with a respective one of end caps 120A-120N (end caps 120).

As noted above, vendors (e.g., manufacturers, wholesalers, etc.) associated with the retailer for store locations 100A-100N may submit products or a suite of products (or “program”) to the retailer for placement on check-out lane end caps in each of the store locations, including check-out lane end caps 120A-120N for check-out lanes 110A-110N in store location 100A. For convenience, the products that may be selected for end cap placement in the following examples are referred to generically as “programs” or “product programs.” A product program may include a single product or a number of products. Multiple products in a single program may be related by tangible characteristics, e.g. size, packaged product count, product category, etc or intangible characteristics, e.g. price, profitability, affinity, etc., or may be unrelated to one another. In some examples, check-out lane end caps in store locations 100A-100N may represent sought-after areas, as customers may be more likely to make impulse purchases immediately prior to check-out. However, retail store locations 100A-100N may include fewer total check-out lane end caps than the total number of products or product programs submitted by the vendors of the retailer. As such, examples according to this disclosure are directed to selecting the products and/or programs for placement in particular stores and particular check-out lane end caps within each store to increase sales performance, including increasing the volume of units sold, the total sales revenue, and/or the profit realized from sales of the products.

in one example according to this disclosure, a subset of product programs that are submitted by vendors of a retailer for placement on check-out lane end caps, such as end caps 120 of retail store location 100A may be selected for placement on the end caps. These program selection techniques may be implemented in a variety of ways, including through the use of one or more computing devices (not shown for ease of illustration purposes only). In one example, one or more upstream business entities (e.g., vendors, suppliers, etc.) may submit a plurality of programs to a retail chain for end cap placement. The people or groups submitting bids for end cap placement may also be employees of the retail chain into which the products are to be placed. For example, the retail chain may employ merchant buyers that work with and promote one or more vendor programs from within the retail chain organization. In any event, the retail chain may, upon receipt of bids for program end cap placement, be responsible for distributing one or more of these programs to store locations 100 for placement on end caps, such as one or more of end caps 120 in store location 100A. In many scenarios, the number of programs submitted thr end cap placement may exceed the number of end caps available in all of store locations 100.

The retail chain may implement the program selection techniques described herein to select one or more of the submitted programs as being eligible for end cap placement. For example, vendors of the retailer submit a number of requests for placement of a number of products in end caps and, as an initial step, the retailer selects a subset of products from the total requests from all of the vendors for consideration for placement in store check-out lane end caps. The selected programs may be referred to herein as an “eligible pool.” The retail chain may select the eligible pool based on various criteria and/or constraints. One example of such a constraint may be retail price of the program. For instance, the retail chain may restrict the eligible pool to programs that sell at retail for prices not exceeding 15 United States dollars (USD or $). Another example of a constraint may be profitability. For instance, the retail chain may limit the eligible pool to programs for which the retail sales price exceeds the cost price by at least a threshold percentage. Additionally, the retail chain may enforce one or more constraints, alone or in any combination, in selecting programs for the eligible pool.

In one example, the retail chain may select the eligible pool of product programs from the total number of bids submitted thr end cap placement based on historical sales data for the programs across all store locations. For example, each of the programs submitted for end cap placement may be associated with a sales metric representative of sales performance of the program across all store locations 100. In one example, the programs submitted for end cap placement may be ordered according to total sales dollars across all store locations 100. In one example, the product programs submitted for end cap placement may be ordered according to the total number of units sold across all store locations 100. In any event, the eligible pool of programs may be selected from this list of programs ordered based on all store locations 100 sales metric(s) by, for example, selecting only a threshold number of the top selling programs. For example, the eligible pool of programs may be the top 100 sales revenue programs across all store locations 100. In one example, the eligible pool of product programs may be equal to the total number of check-out lane end caps across all store locations 100, including end caps 120A-120N in store location 100A.

Upon selecting the eligible pool for check-out lane end cap placement, the retail chain may assign a priority level to each program of the eligible pool. Each priority level may correspond to a particular check-out lane end cap (e.g., priority level may be associated with the end cap of check-out lane #1, etc.). Additionally, the retail chain may determine a total number of stores to which to dispatch each program of the eligible pool. In the example of FIG. 1, the retail chain may dispatch the $5 DVD program, at a priority level of ‘1’ to a number of retail store locations 100, including retail store location 100A. In other words, retail store location 100A may receive the $5 DVI) program with a predetermined priority level of ‘1’ attached to it. Based on the $5 DVD program having a priority level of ‘1,’ the retail chain may place the $5 DVD program on end cap #1 of retail store location 100A. In this example, end cap #1 may be associated with priority level ‘1’ based on various criteria, such as past sales generated by programs placed on end cap #1, visibility/accessibility to shoppers, etc.

In some examples, the retail chain may assign a single priority level to multiple programs. In these examples, the retail chain may implement the techniques of this disclosure to assign a store classification to each program with a shared priority level. For example, the soft drink program may share the priority level of 2 with a candy bar program. In this example, the retail chain may assign a priority level of ‘2A’ to the soft drink program and a priority level of ‘2B’ to the candy bar program. In this instance, ‘A’ and ‘B’ may represent store classifications. More specifically, the retail chain may place the soft drink program on the second end cap of those retail store locations with an ‘A’ classification and on the second end cap of those retail store locations with a ‘B’ classification. In the specific example of FIG. 1, retail store location 100A may have an ‘A’ classification (as demonstrated by the sunglasses program being placed on second end cap 120B), while another one or more of retail store locations 100 may have a ‘B’ classification, and consequently have the candy bar program placed on the respective second end caps.

In various implementations, the retail chain may then determine a sales performance metric for each program that is specific to the performance of the product in a particular location of the retail store locations 100. The sales performance metric may be based on historical sales data associated with each program at each of retail store locations 100. The sales performance metric and the sales data upon which it is based may be representative of any facet of sales performance of a product program including, e.g., sales revenue, profitability, or number of units. An example program may include digital video discs (DVDs) that retail at a price of $5 or less. Past sales revenue (or the “top line”) of $5 DVDs at retail store location 100A may meet or exceed a threshold amount. Based on the top line of $5 DVDs at retail store location 100A in the past, the retail chain may assign a particular sales performance metric to the $5 DVD program associated with sales of that program in retail store location 100A. For purposes of illustration, the sales metric may be a highest possible sales metric of all programs in the eligible pool. Based on assigning the highest possible sales metric to the $5 DVD program, the retail chain may generate a decision value pertaining to placement of the $5 DVD program on an end cap of retail store location 100A. The decision value may conform to a binary format (i.e., the value is selected from either a ‘1’ or a ‘0’) value. A decision value of “1” with respect to the $5 DVD program at retail store location 100A may denote a decision to place the $5 DVD program on one or more of end caps 120. On the other hand, a decision value of ‘0’ with respect to the $5 DVD program at retail store location 100A may denote a decision to not place the $5 DVD program on any of end caps 120.

Techniques of this disclosure may be implemented on a periodic basis. For example, the retail chain may reseed programs for the eligible pool, reevaluate sales performance, and reassign sales metrics at predetermined intervals. Each interval may correspond with the beginning of a so-called “season.” Examples of seasons may include a winter Holiday season (e.g., November 2^{nd} through December 31^{st} of each year), a Halloween season (e.g., August 21 through November 1^{st} of each year), a summer season, a back-to-school season, and so on. The retail chain may select a current season based on a current date and the current date's intersection with a particular time span. In one example, the retail chain may calculate the sales metrics based on past sales data corresponding to sales that occurred during the corresponding season of one or more prior years. Thus, in some examples, the sales performance of various programs and the ultimate decision regarding placement of such programs on check-out lane end caps may be specific to particular times or time periods, including, e.g. times of the year. It should be noted that the seasons or other periods of time that are employed may have different or similar lengths of time, as the case may be In this manner, techniques of this disclosure may enable a retail chain to determine end cap placement of programs based on various relevant criteria, with different goals such as increasing profits (or the “bottom line sales”).

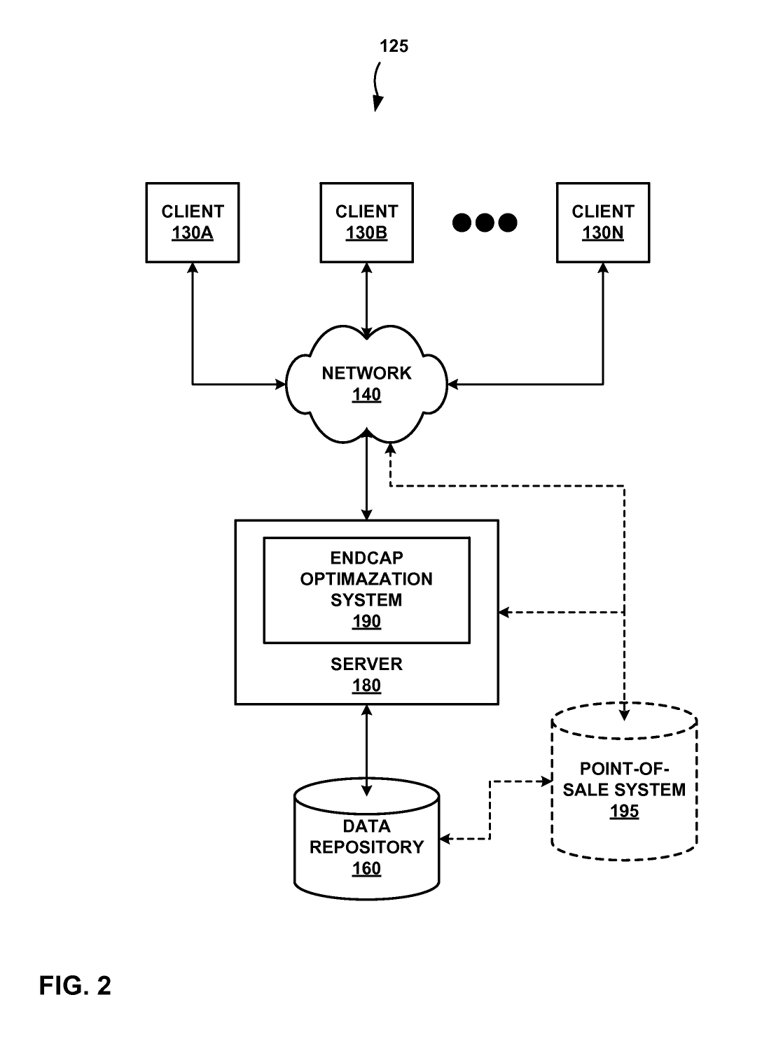

FIG. 2 is a conceptual diagram illustrating example system 125 for performing end cap optimization. In the example of FIG. 2, system 125 includes including client computing devices 130A-130N (collectively “clients 130” or individually “client 130”), network 140, data repository 160, point-of-sale (POS) system 195, and server 180. Clients 130 are communicatively connected to data repository 160, server 180, and point-of-sale (POS) system 195 via network 140. Clients 130 may include any number of different electronic devices, including desktop computers, workstations, network terminals, cash registers, and mobile computing devices such as personal digital assistants (PDAs), smartphones, tablet computers, inventory scanners, laptop computers, netbooks, ultrabooks, and others. Clients 130 and server 180 are configured to periodically communicate with one another over network 140 to track and store, e.g. in data repository 160, historical sales data for store locations at which clients 130 are located. Additionally, server 180 may include end cap optimization system (EOS) 190, which may be configured or otherwise operable to utilize data supplied by one or more of clients 130, data repository 160, and POS system 195 to improve sales and/or profits resulting from placement of product programs on check-out lane end caps of the store locations associated with clients 130. In various implementations, data repository 160 and/or POS system 195 may store sales data clients 130 associated with one or more store locations. Examples of such data may include past sales data of products (e.g., product programs through check-out lane end caps), profits generated by the past sales, sales performance of one product program in relation to other product programs on check-out lane end caps, etc. Past sales data may be collected for product programs across all stores and/or in-store sales data may be collected and stored representing sales performance of a product program in a particular store location.

Clients 130 may be client computers from which users access and interact with EOS 190. For example, clients 130 may run a web browser that accesses and presents a web application served up by server 180 or another device and allows a user to execute an end cap optimization in accordance with the examples of this disclosure. In another example, clients 130 may execute an application outside of a web browser, e.g. an operating system specific application like a Windows application or Apple OS application that accesses and presents a web application served up by server 180 or another device and allows a user to execute an end cap optimization in accordance with the examples of this disclosure. In another example, one or more of clients 130 may store and execute EOS 190 locally.

EOS 190 may use data obtained from clients 130, data repository 160 and POS system 195 to optimize placement of product programs on check-out lane end caps at various store locations. For example, EOS 190 may select the eligible pool of product programs based on various criteria, such as retail price constraints, profitability constraints, and others. Additionally, EOS 190 may determine a sales performance metric for each product program of the eligible pool in relation to each store location. In various examples, EOS 190 may determine each individual sales metric based on one or more of past sales of each product program at each store location, profits generated by each program-location combination, and other factors associated with a particular product program and/or store location, such as shopper demographics, per capita purchase amounts, etc.

Additionally, EOS 190 may assign an end cap priority level to each product program of the eligible pool. Each end cap priority level may correspond to a particular end cap number at a store location. In other words, the available end cap priority levels may form data input to EOS 190 from various sources, such as data repository 160 and/or POS system 195. Using the input of end cap priority levels from these various sources, EOS 190 may assign each product program of the eligible pool to a particular end cap priority level. More specifically, if EOS 190 determines that a particular product program (e.g., $5 DVDs has the highest sales metric of the eligible pool, EOS 190 may assign, or map, the $5 DVD program to the end caps associated with priority level ‘1.’ In examples according to this disclosure, check-out lane end caps may be associated with priority levels based on various criteria, such as shopper visibility, shopper access, average customer traffic of a corresponding check-out lane, and others. For instance, a check-out lane end cap may have a priority level of ‘1’ if the check-out lane associated with the end cap has the highest average customer traffic of the all available check-out lanes. In various examples, a checkout lane may experience greater customer traffic because the lane is located proximate to the store exits, through designation as a so-called “express check-out lane” (e.g., by specifying a maximum number of items that a shopper may purchase at the express check-out lane), and other factors. The priority levels associated with the check-out lane end caps may be in a predetermined order, thus providing a hierarchy by which product programs may be placed on the end caps.

EOS 190 may be further configured to allocate the product programs of the eligible pool to particular store locations. In general, EOS 190 is configured to allocate the product programs of the eligible pool to particular store locations such that the allocation results in improved sales performance of the programs for a given time period, e.g., for a season. EOS 190 may function to improve sales performance by employing an optimization algorithm(s) configured to optimize the placement of the product programs in particular end caps within particular store locations for a particular sales metric, e.g. top tine or bottom tine or total volume of units. Additionally, the end cap optimization algorithm(s) executed by EOS 190 may be subject to a number of constraints, including, e.g., the total number of stores into which each product program is required to be placed, the number of end caps in each store and the end cap priority level of each end cap, and the end cap priority level assigned to each program. EOS 190 may employ any of a number different optimization techniques or models to optimize placement of product programs in end caps in a number of store locations. For example, EOS 190 may employ a number of different linear programming techniques to optimize placement of product programs in end caps in a number of store locations. In one example, mixed integer programming (1411P) may be used to optimize placement of product programs in end caps in a number of store locations.

In some scenarios, EOS 190 may assign the product programs based on a number of available check-out lane end caps at the store locations. For instance, if a particular store location includes ten available check-out lane end caps, EOS 190 may allocate ten product programs of the eligible pool to the store location. In these and other scenarios, EOS 190 may categorize the store locations into groups, with each group being associated with a store classification. EOS 190 may add the store classification as a second dimension in assigning and allocating product programs to check-out lane end caps of the store locations. For example, EOS 190 may assign the same priority level (e.g., level ‘5’) to three different product programs of the eligible pool. In addition, EOS 190 may delineate the three product programs by adding a store classification as a second dimension to the assigned priority levels. In the specific example described above, EOS 190 may assign priority levels of ‘5A,’ ‘5B,’ and ‘5C’ to the three product programs. Based on these assigned priority levels, EOS 190 may allocate the first of the three programs to end cap #5 of those store locations having an ‘A’ classification, the second program to end cap #5 of those store locations having an ‘B’classification, and the third program to end cap #5 of those store locations having ‘C’ classification.

Functionalities described above with respect to EOS 190 may provide various advantages. In general, EOS 190 may improve sales and/or profits by optimizing the placement of various product programs on check-out lane end caps of a number of store locations. In various examples, EOS 190 may select certain product programs to form an eligible pool for check-out lane end cap placement, determine sales metrics for each program-store combination, receive input mapping particular end caps to priority levels in a predetermined order, and assign an end cap priority level to each program of the eligible pool, and allocate the programs to particular store locations, after which the retailer may place each program on the assigned end cap at the allocated store. In this manner, EOS 190 may optimize the use of check-out lane end caps available across store locations, by efficiently placing product programs on the end caps to maximize sales and/or resulting profits.

Techniques described with respect to FIG. 2 may be implemented, at least in part, in hardware, software, firmware, or any combination thereof. Network 140 may include one or more terrestrial and/or satellite networks interconnected to provide a means of communicatively connecting clients 130 to data repository 160 and server 180. For example, network 140 may be a private or public local area network (LAN) or Wide Area Network (WANs). Network 140 may include both wired and wireless communications according to one or more standards and/or via one or more transport mediums. For example, network 140 may include wireless communications according to one of the 802.11 or Bluetooth specification sets, or another standard or proprietary wireless communication protocol. Network 140 may also include communications over a terrestrial cellular network, including, e.g. a GSM (Global System for Mobile Communications), CDMA (Code Division Multiple Access), EDGE (Enhanced Data for Global Evolution) network. Data transmitted over network 140, e.g., from clients 130 to data repository 160 may be formatted in accordance with a variety of different communications protocols. For example, all or a portion of network 140 may be a packet-based, Internet Protocol (IP) network that communicates data from clients 130 to data repository 160 in Transmission Control Protocol/Internet Protocol (TCP/IP) packets, over, e.g., Category 5, Ethernet cables.

Data repository 160 and/or POS system 195 may each include, e.g., a standard or proprietary electronic database or other data storage and retrieval mechanism. Data repository 160 and/or POS system 195 may be implemented in software, hardware, and combinations of both. For example, data repository 160 and/or POS system 195 may include proprietary database software stored on one of a variety of storage mediums on a data storage server connected to network 140 and configured to store information associated with past sales data, profits earned, identification information associated with store locations and check-out lane end caps, and various others. Storage media included in or employed in cooperation with data repository 160 and/or POS system 195 may include, e.g., any volatile, non-volatile, magnetic, optical, or electrical media, such as a random access memory (RAM), read-only memory (ROM), non-volatile RAM (NVRAM), electrically-erasable programmable ROM (EEPROM), flash memory, or any other digital media.

Server 180 may be any of several different types of network devices. For example, server 180 may include a data processing appliance, web server, specialized media server, personal computer operating in a peer-to-peer fashion, or another type of network device. Additionally, although example system 125 of FIG. 2 includes a single server 180, other examples may include a number of collocated or distributed servers configured to process check-out lane end cap program placement and other types of data associated with clients 130 and the respective store locations associated with clients 130 and stored in data repository 160 and/or POS system 195 individually or in cooperation with one another.

Although data repository 160, POS system 195, and server 180 are illustrated as separate components in example system 125 of FIG. 2, in other examples two or more of these components may be combined or may each be distributed amongst more than one device. For example, server 180 may store data repository 160 and/or POS system 195 and control the corresponding data to periodically store data associated with clients 130 and the associated store locations. In another example, data repository 160 may be distributed among a number of separate devices, e.g. a number of database servers, and server 180 may include a number of co-located or distributed servers configured to operate individually and/or in cooperation with one another and with the various devices comprising data repository 160.

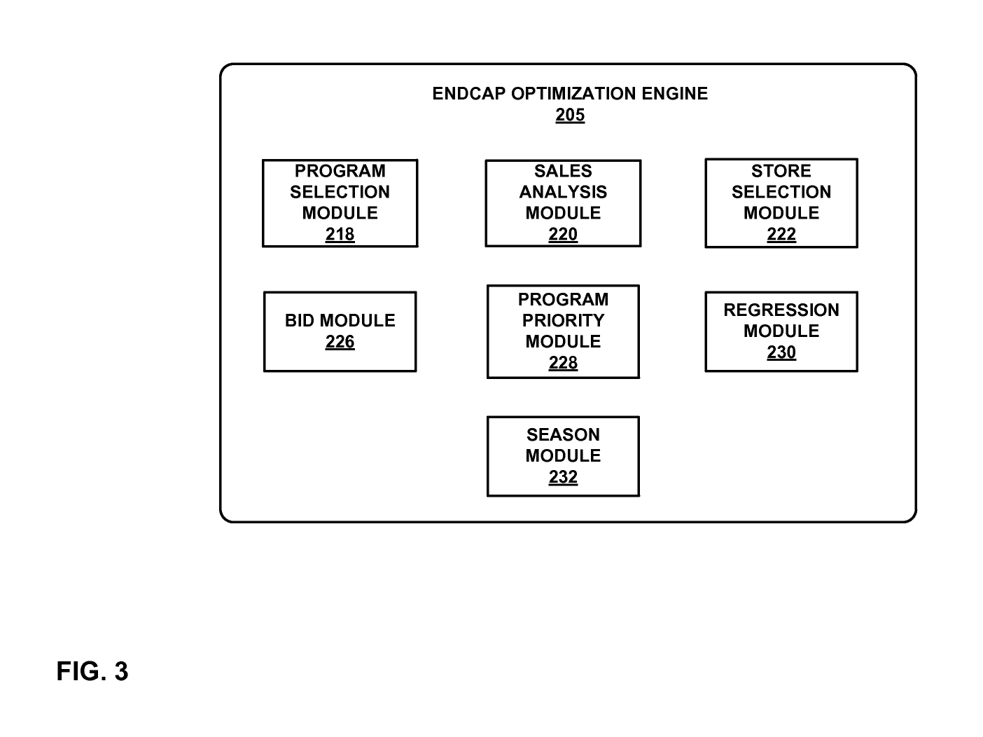

FIG. 3 is a block diagram illustrating end cap optimization engine 205. End cap optimization engine 205 is one example configuration of EOS 190 described with respect to FIG. 2. End cap optimization engine 205 may, for example, comprise any combination of one or more processors, one or more field programmable gate arrays (FPGAs), one or more application specific integrated circuits (ASICs), and one or more application specific standard products (ASSPs). End cap optimization engine 205 may also comprise memory, both static (e.g., hard drives or magnetic drives, optical drives, FLASH memory, EPROM, EEPROM, etc.) and dynamic (e.g., RAM, DRAM, SRAM, etc.), or any other non-transitory computer readable storage medium capable of storing instructions that cause the one or more processors to perform the check-out lane end cap program placement techniques described in this disclosure. Thus, end cap optimization engine 205 may represent hardware or a combination of hardware and software to support the below described components, modules or elements, and the techniques should not be strictly limited to any particular embodiment described below.

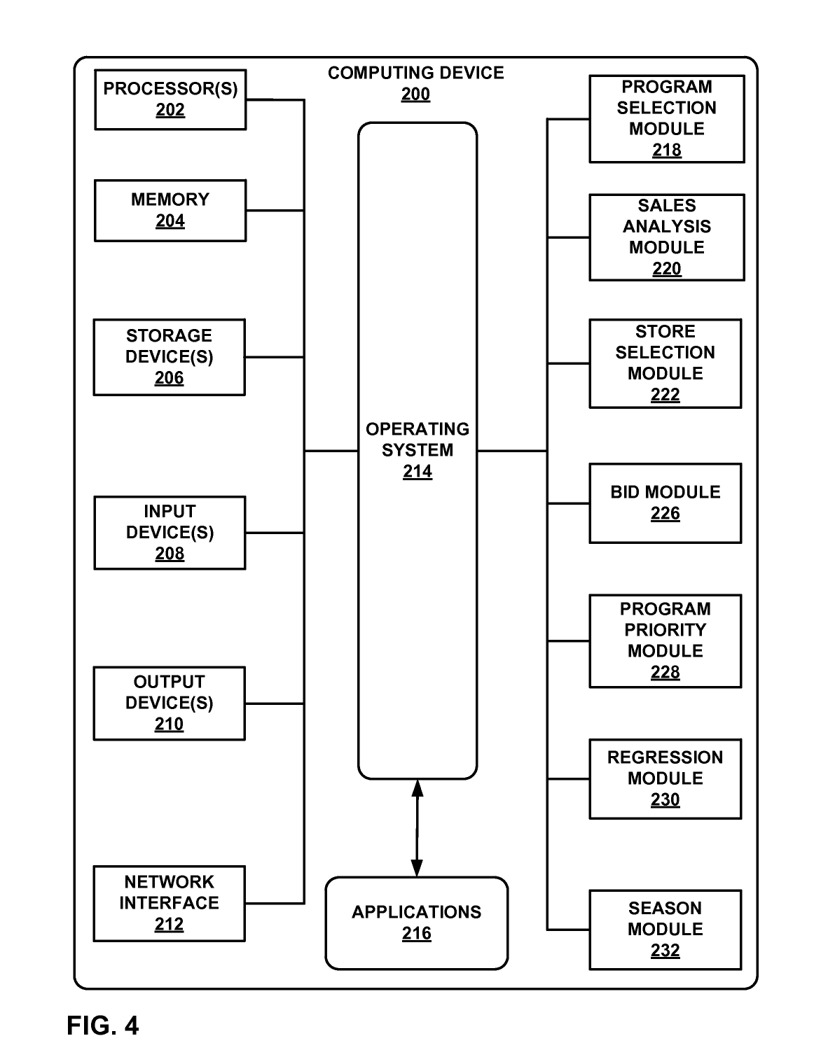

In the example illustrated in FIG. 3, end cap optimization engine 205 includes program selection module 218, sales analysis module 220, store selection module 222, bid module 226, program priority module 228, regression module 230, and season module 232. Specific aspects and functions of these components of end cap optimization engine 205 are described in more detail with respect to FIG. 4 below. In various implementations, one or more of program selection module 218, sales analysis module 220, store selection module 222, bid module 226, program priority module 228, regression module 230, and season module 232 may be implemented externally to end cap optimization engine 205. Additionally, in various implementations, two or more components of end cap optimization engine 205 may be combined into a single module (e.g., program selection module 218 and bid module 226 may form a single module). In this manner, techniques described herein may be implemented through a variety of implementations.

FIG. 4 is a block diagram illustrating details of an example computing device 200 that may implement end cap optimization techniques, in accordance with one or more aspects of this disclosure. As shown in the example of FIG. 4, computing device 200 includes one or more processors 202, memory 204, one or more storage devices 206, one or more input devices 208, one or more output devices 210, and network interface 212. One or more processors 202 are, in some examples, configured to implement functionality and/or process instructions for execution within computing device 200. For example, processors 202 may process instructions stored in memory 204 and/or instructions stored on storage devices 206. Such instructions may include components of operating system 214, program selection module 218, sales analysis module 220, store selection module 222, bid module 226, program priority module 228, regression module 230, season module 232, and one or more applications 216. Computing device 200 may also include one or more additional components not shown in FIG. 4, such as a power supply (e.g., a battery), among others.

In some examples, computing device 200 may include a control unit (not shown for ease of illustration purposes only). The control unit may further include one or more of program selection module 218, sales analysis module 220, store selection module 222, bid module 226, program priority module 228, regression module 230, season module 232, and one or more applications 216. The control unit may, for example, comprise any combination of one or more processors, one or more field programmable gate arrays (FPGAs), one or more application specific integrated circuits (ASICs), and one or more application specific standard products (ASSPs). The control unit may also comprise memory, both static (e.g., hard drives or magnetic drives, optical drives, FLASH memory, EPROM, EEPROM, etc.) and dynamic e.g., RAM, DRAM, SRAM, etc.), or any other non-transitory computer readable storage medium capable of storing instructions that cause the one or more processors to perform the efficient network management techniques described in this disclosure. Thus, the control unit may represent hardware or a combination of hardware and software to support the below described components, modules or elements, and the techniques should not be strictly limited to any particular example configurations described below.

Memory 204, in one example, is configured to store information within computing device 200 during operation. Memory 204, in various examples, is described as a computer-readable storage medium and/or a computer-readable storage device. In some examples, memory 204 is a temporary memory, meaning that a primary purpose of memory 204 may not be long-term storage. Memory 204, in some examples, is described as a volatile memory, meaning that memory 204 does not maintain stored contents when memory 204 is not receiving power. Examples of volatile memories include random access memories (RAM), dynamic random access memories (DRAM), static random access memories (SRAM), and other forms of volatile memories. In some examples, memory 204 is used to store program instructions for execution by processors 202. Memory 204, in one example, is used by software (e.g., operating system 228) or applications (e.g., one or more applications 230) executing on computing device 200 to temporarily store information during program execution.

One or more storage devices 206, in some examples, also include one or more computer-readable storage media, such as a computer-readable storage device. In some examples, storage devices 206 may be configured to store greater amounts of infbrmation than memory 204. Storage devices 206 may further be configured for tong-term storage of information. In some examples, storage devices 206 include non-volatile storage elements. Examples of such non-volatile storage elements include magnetic hard discs, optical discs, solid state discs, floppy discs, flash memories, forms of electrically programmable memories (EPROM) or electrically erasable and programmable memories, and other forms of non-volatile memories.

As shown in FIG. 4, computing device 200 may also include one or more input devices 208 and one or more output devices 210. Input devices 208 may include one or more of a keyboard, mouse, stylus, still camera, video camera, microphone, and other devices that are capable of receiving user input. Output devices 210 may include one or more of a monitor, speaker, video graphics adapter card, sound card, and any other device capable of generating output that may be intelligible to a user. Input devices 208 and/or output devices 210 may also include a touchscreen, presence-sensitive display, or any other input/output capable displays known in the art.

Computing device 200, in some examples, also includes network interface 212. Computing device 200, in one example, utilizes network interface 212 to communicate with external devices via one or more networks, such as one or more wireless networks. Network interface 212 may be a network interface card, such as an Ethernet card, an optical transceiver, a radio frequency transceiver, or any other type of device that can send and receive information. Other examples of such network interfaces may include Bluetooth®, 3G, 4G and WiFi® radios in mobile computing devices as well as USB. In some examples, computing device 200 utilizes network interface 312 to wirelessly communicate with external devices over a network, e.g. like server 180 communicating with clients 130 over network 140 as illustrated in FIG. 4.

Operating system 214 may control one or more functions of computing device 200 and/or components thereof. For example, operating system 214 may interact with one or more of program selection module 218, sales analysis module 220, store selection module 222, bid module 226, program priority module 228, regression module 230, season module 232, and one or more applications 216. Additionally, operating system 214 may facilitate one or more interactions between program selection module 218, sales analysis module 220, store selection module 222, bid module 226, program priority module 228, regression module 230, season module 232, and one or more applications 216 and one or more of processors 202, memory 204, storage devices 206, input devices 208, and output devices 210. As shown in FIG. 4, operating system 214 may interact with or be otherwise coupled to program selection module 218, sales analysis module 220, store selection module 222, bid module 226, program priority module 228, regression module 230, season module 232, and one or more applications 216, and components thereof.

In some examples, operating system 214 may include or otherwise provide functionalities described with respect to one or more of program selection module 218, sales analysis module 220, store selection module 222, bid module 226, program priority module 228, regression module 230, season module 232, and one or more applications 216. In these and other examples, one or more of program selection module 218, sales analysis module 220, store selection module 222, bid module 226, program priority module 228, regression module 230, and season module 232 may be included in applications 216. In other examples, one or more of program selection module 218, sales analysis module 220, store selection module 222, bid module 226, program priority module 228, regression module 230, and season module 232 may be implemented externally to computing device 200, such as at a network location. In some such instances, computing device 200 may use network interface 212 to access and implement functions provided by one or more of program selection module 218, sales analysis module 220, store selection module 222, bid module 226, program priority module 228, regression module 230, season module 232, and one or more applications 216 and its components, through methods sometimes referred to as server side processing or cloud computing.

Program selection module 218 may be configured or otherwise operable to implement one or more program selection techniques described herein. As discussed, a retail chain that uses computing device 200 may need to select a subset of programs submitted for end cap placement, particularly in scenarios where the number of submitted programs exceeds an available number of end caps. Program selection module 218 may select the subset (or eligible pool) of programs by applying various constraints, such as retail price limits, bottom line information, and others. In selecting and applying the constraints, program selection module 218 may include one or more factors or considerations. For example, program selection module 218 may select constraints that suit consumer tendencies as it relates to the location of the check-out lane end caps.

More specifically, the selected constraints employed by program selection module 218 may be related to a consumer tendency commonly known as “impulse buying” or “impulse purchasing.” Consumers, such as shoppers at a retail store location, may enter the retail store location with predetermined plans to purchase certain items. However, while shopping at the retail store location for the planned purchases, a consumer may also make one or more unplanned (or “impulse”) purchases. In turn, a retail chain may determine that certain items are more likely to be purchased on impulse (hereinafter, “impulse items”).

Demand for certain impulse items may be independent of time of year, season, holidays, occasions, etc. For example, items such as chewing gum, magazines, etc. may generate consistent impulse-based sales throughout a particular year. On the other hand, certain items may generate substantial impulse-based sales at specific times of the year, based on such variables as weather, special occasions, and others. For example, bags of bite size candy may generate substantial impulse-based sales during the weeks preceding the occasion of Halloween, which is observed on October 31^{st} of every year. In many situations, consumers may not be accustomed to shopping for bite size candy, and thus neglect to plan to purchase bite size candy during the weeks preceding Halloween. In these situations, bite size candy may form an impulse purchase for a potentially large number of consumers at any given retail store location.

To bring an impulse item to the attention of consumers at a retail store location, the retail chain may rely on intelligent placement of the impulse item within the store. Often, a check-out lane end cap forms an effective location to bring impulse items to the attention of the consumers. More specifically, most consumers make some type of purchase on a given visit to the retail store location. As a result, these consumers must pass through a check-out lane of the retail store location, in order to pay thr the purchased item(s). By placing impulse items on one or more check-out lane end caps of the retail store location, the retail chain may more effectively bring the impulse items to the attention of a broad consumer base. Additionally, a consumer may need to wait in line at the check-out lane while preceding shoppers complete their transactions. In these scenarios, the check-out lane end cap may provide an efficient way to place the impulse items in the waiting consumer's view for an extended period of time. In still other scenarios, consumers may shop in groups (e.g., with family members). In such instances, one or more consumers in the group may take notice of the impulse items on the check-out lane end cap while others in the group are otherwise occupied placing items on a conveyor belt of the chedc-out lane, paying, etc. Those consumers in the group who notice the impulse items may alert the others in the group, leading to a collaborative purchase of the impulse item.

Additionally, program selection module 218 may select programs that include various numbers of products. Certain programs may include multiple instances of the same or similar item, such as the $5 DVD program described with respect to FIG. 1. In the instance of the $5 DVD program, each item may conform to the same form factor and structure (a DVD case), but may differ in terms of content (e.g., the specific movie, television show, or game that is stored to the DVD). In other examples, program selection module 218 may select a program that consists of two or more products. Products within a program may be related to one another in a variety of ways. For example, a program may consist of food items that are often consumed in combination tortilla chips and salsa). In this example, a consumer may purchase varying quantities of the products in the chips & salsa program. However, based on broader consumer trends, the chips & salsa program may consist of one or more predetermined chip bag-to-salsa jar ratios.

Computing device 200 also includes sates analysis module 220. Sales analysis module 220 may be configured or otherwise operable to process past sales data corresponding to one or more programs of the eligible pool. In processing the past sales data corresponding to a particular program, sales analysis module 220 may also consider additional factors, such as seasons and weather conditions when the past sales occurred, whether or not the program was placed on a check-out lane end cap at the time of sale, the retail store location(s) where the past sales occurred, etc.

Sales analysis module 220 may perform one or more operations to output sales data used by program selection module 218 and other components of computing device 200. In some examples, sales analysis module 220 may normalize past sales data in order to generate a sales performance metric for a program. More specifically, sales analysis module 220 may scale values such as sales volume, top line data, etc, to compensate for variances from one store location to the next. For example, sales analysis module 220 may compensate for size differences between different store locations by calculating top line data as a percentage of total sales at each store. As another example, sales analysis module 220 may generate a “chain average” of top line or sales volume of a program. In this example, sales analysis module 220 may compare the past sales data from each store location to the chain, all store locations or a number of store locations in a group of stores, average to generate a sales performance metric. The chain average may represent one or more of a mean, median, or mode value with respect to the past sales data of a given program. In this manner, sales analysis module 220 may account for varying characteristics among store locations served by the retail chain and may normalize sales data such that data from different locations may be meaningfully compared to one another.

As shown in FIG. 4, computing device 200 may also include store selection module 222. Store selection module 222 may be configured or otherwise operable to map programs of the eligible pool to particular retail store locations. For example, store selection module 222 may receive sales performance metrics of each program of the eligible pool in relation to each available retail store location. Based on the received sales performance metrics, store selection module 222 may assign each program to particular store locations. For example, store selection module 222 may deter nine that a sunglasses program has a strong sales performance metric with respect to store location 1, but has a weak sates performance metric with respect to store location 2. In this example, store selection module 222 may assign the sunglasses program for cheek-out lane end cap placement in store location 1, but not in store location 2. It will be appreciated that, in this example, store location 2 may still carry one or more products of the sunglasses program, though not via placement on a check-out lane end cap.

Computing device 200 may also include bid module 226. Bid module 226 may receive and otherwise process bids from suppliers to place one or more programs in the eligible pool. As described with respect to program selection module 218, a retail chain that uses computing device 200 may select the eligible pool from a larger set of programs. In some examples, suppliers may compete by placing bids associated with various programs for check-out lane end cap placement. In various situations, suppliers may place bids that indicate the cost that the retail chain would pay for the program (i.e., “cost price”), volume of the program's products to be supplied, expected turnaround time for the supplier to replenish stock of the program's products, the total number of stores into which the product is to be placed on an end cap, and others. Bid module 226 may be configured or otherwise operable to process the received bids and output the processed data to other components of computing device 200, such as program selection module 218. In examples, bid module 226 may rank the received bids and output the rankings to program selection module 218. Bid module 226 may rank the received bids based on criteria included in the bid, such as the examples listed above. While shown separately in FIG. 4 for purposes of clarity, bid module 226 and program selection module 218 may share one or more functionalities in various implementations.

Program priority module 228 of computing device 200 may be configured or otherwise operable to assign an end cap number (and optionally, a class of stores) to each program of the eligible pool. In various implementations, program priority module 228 may utilize data output by one or more of sales analysis module 220, bid module 226, and other components of computing device 200. In one example, program priority module 228 may determine that the $5 MD program has the highest potential profitability of all programs of the eligible pool. In this example, program priority module 228 may assign a priority level of ‘1’ (in this case, a top priority) to the $5 DVD program. By assigning the top priority to the $5 DVD program, program priority module 228 may instruct the retail chain to deploy the $5 DVD program to end cap #1 of each available store location. In some instances, assigning the top priority may ensure that the $5 DVD program receives end cap placement at every store location served by the retail chain, as each store location may have at least one check-out lane end cap. In one illustrative example, the store locations served by the retail chains may have a minimum of 8 check-out lane end caps. In this example, program priority module 228 may ensure end cap placement at all available stores for the programs having priority levels ‘1’ through ‘8.’

Each priority level may correspond to a particular end cap at one or more store locations. As an illustrative example, priority level ‘1’ may correspond to end cap 120 placed at the end of cheek-out lane 110A in store location 100A. Additional store locations of store locations 100A-100N may also include a priority level ‘1’ end cap. The retail chain may map priority levels to particular end caps 120 based on various criteria, such as proximity to an exit area of a store location, average customer traffic of corresponding check-out lanes, etc. Additionally, the priority levels may be in a predetermined order, such as ascending or descending orders. In some examples, a bid associated with a particular product program may include a desired priority level. In these examples, an entity submitting the bid may seek that the program be placed only on end caps having the specified priority level, if the submitted program is selected to the eligible pool. In other words, the program bids may indicate that if the desired priority level is not available to the submitted product, that the submitted product be removed from consideration for the eligible pool.

In some instances, program priority module 228 may add a second dimension, such as a store classification, to one or more priority levels assigned to programs of the eligible pool. As one illustrative example, program priority module 228 may assign an absolute priority level of ‘1’ to the $5 DVD program. In this example, program priority module 228 may assign priority levels of ‘2A’ and ‘2B’ to a greeting card program and a toy program respectively. In this example, the retail chain may use the assigned priorities to allocate the greeting card program to end cap #2 of those store locations having an ‘A’ classification, and the toy program to end cap #2 of those store locations having a ‘B’ classification. In various implementations, one or more components of computing device 200 may assign the store classification based on various criteria, such as past sales of a program at a store location, as output by sales analysis module 220. In some implementations, computing device 200 may include a dedicated component, such as a store classification module (not shown for ease of illustration purposes only), to assign classifications to various store locations. By assigning priorities that are qualified by store classifications, program priority module 228 may ensure that a single store location does not stock two or more programs having the same priority level on check-out lane end caps.

As discussed, different retail store locations may have different characteristics, such as available floor space, number of check-out lanes, variety and amount of inventory stocked, and others. Certain larger store locations, such as a superstore, may have a greater number of check-out lanes, thus increasing the number of available check-out lane end caps. In some instances, a store location may have more available end caps than the number of programs in the eligible pool. For example, at a given point of time (e.g., through a particular season), the eligible pool may include 10 programs, while a particular store location (e.g., a superstore), may have 19 available end caps. As a result, the superstore may only receive 10 programs (or less, in the event that multiple programs share the same priority level separated by store classifications) with which to populate the 19 end caps. In such a scenario, program priority module 228 and/or other components of computing device 200 may cause the superstore to “cycle” the offered programs. More specifically, if the superstore receives 10 programs, computing device 200 may cause the superstore to place each offered program on each of the end caps #1 through #10. Additionally, computing device 200 may cause the superstore to place those programs having priority levels ‘1’ through ‘9’ on the remaining 9 available end caps. In this manner, techniques of this disclosure may adapt to varying numbers of available end caps across retail store locations, and dispatch programs for end cap placement accordingly.

In some scenarios, the retail chain using computing device 200 may serve store locations that are relatively new. In these scenarios, the new store locations may not be associated with past sales data, or may not have past sales data dating back a sufficient amount of time on which to base end cap placement determinations. Regression module 230 of computing device 200 may be configured or otherwise operable to map each new store location to a corresponding model store.

More specifically, regression module 230 may use characteristics of a new store location to determine which existing store location is most similar. Based on the determination, regression module 230 may map the existing store location as a model store for the new store location. Further, regression module 230 may cause sales analysis module 220 to apply historical sales data of the model store to the new store location, thereby enabling other components of computing device 200 to perform end cap-related determinations for the new store location. In some specific examples, regression module 230 may determine store similarity based on criteria such as one or more of physical proximity, local demographic information, store size, inventory requisitions, and others. Based on information associated with the model store to which the new store is mapped, regression module 230 may cause computing device 200 to implement the end cap optimization techniques described herein with respect to the new store. In this manner, techniques of this disclosure may extend to new stores with no or insufficient sales data on which to base end cap optimization determinations.

As described with respect to FIG. 1, the retail chain using computing device 200 may reevaluate end cap-based determinations on a season-by-season basis, due to varying consumer purchasing trends during different seasons. Season module 232 may be configured or otherwise operable to delineate seasons based on calendar dates, social or cultural occasions, and other criteria. As described in an example above, season module 232 may allot the time span ranging from August 31^{st} through November 1^{st} of each year as a Halloween season. Season module 232 may provide seasonal determinations to program selection module 218 and program priority module 228, as well as other components of computing device 200. For example, season module 232 may interact with sales analysis module 220 to limit the past sales data considered for purposes of end cap program placement to particular periods of time. In this manner, program selection module 218 may ultimately optimize placement of programs across end caps and store locations for improved sales performance in a particular recurring period of time, like a season. Programs associated with the Halloween season may include bite size candy programs, costume programs, etc. Other example seasons may include the Holiday season described above, Super Bowl season (preceding a yearly sporting event known as the Super Bowl, which is associated with mid-size and large social gatherings), and others. Programs associated with the Holiday season may include greeting cards, while programs associated with the Super Bowl season may include the chips & salsa program described earlier.

In one example according to this disclosure, end cap optimization engine 205 may use season module 232 to determine a current season. Season module 232 may determine the current season using various time periods. As an illustrative example, season module 232 may identify twelve distinct seasons, of the same or varying time spans, in a given year. Additionally, program selection module 218 may select the eligible pool from a larger superset of product programs. Program selection module 218 may facilitate selection of the eligible pool by supplying constraints, such as cost prices, profit margins, retail prices, etc. associated with the product programs. In one example, program selection module 218 may select the eligible pool of product programs based at least in part on historical sates data for each of the programs across all of a number of store locations in a retail chain. The sales data across all store locations for each program considered by program selection module 218 may, e.g., be supplied by sales analysis module 220. In some examples, bid module 226 may receive and process bids from parties (e.g., suppliers) of each product program to aid in selection of the eligible pool. For example, bid module 226 may assess various data included as part of the bids, such as cost prices, discounts on the cost prices, projected discounts and profitability, etc. In one example, program selection module 218 may select the eligible pool of product programs from the total number of program bids received and processed by bid module 226.

Additionally, end cap optimization engine 205 may use sales analysis module 220 to determine sales performance information for each product program of the eligible pool in relation to each available store location. For example, sales analysis module 220 may supply top line and/or bottom line data associated with each product program relating to each store location, based on sales in time periods of past years corresponding to the time periods supplied by season module 232. In examples, sales analysis module 220 may generate a sales metric to quantify or otherwise describe the sates performance of each product program in relation to each store location. Using the sales metric generated by sales analysis module 220, program priority module 228 may assign a priority level to each product program of the eligible pool. In one example, as part of the assigning process, program priority module 228 may receive, as input, levels of priority in a predetermined order, as associated with existing check-out lane end caps. Program priority module 228 may select priority levels from the received input, and assign each product program a selected priority level.

Store selection module 222 may allocate the product programs of the eligible pool to various store locations and particular end caps therein. In some examples, store selection module 222 may assign store classifications to various groups of stores. As an example, store selection module 222 may assign, to three different groups of stores, classifications of ‘A,’ ‘B,’ and ‘C.’ Store selection module 222 may add the store classifications as a second dimension to the priority levels obtained from program priority module 228. In examples, store selection module 222 may delineate different product programs assigned to the same priority level by adding different store classifications. Using the delineated priority levels assigned to the product programs of the eligible pool, a retail chain using computing device 200 may ship the product programs of the eligible pool to the store locations for end cap placement for the current season.

In any event, store selection module 222 may allocate the product programs from the eligible pool to store locations and end caps to optimize sales performance across all of the stores. The optimization executed by store selection module 222 may use various programmatic techniques and/or optimization models, including mixed integer linear programming. Additionally, store selection module 222 may optimize product program placement in store location and check-out lane end cap for a number of different sales performance metrics, including, e.g., program sales revenue, profit, or volume. Store selection module 222 may also be configured to optimize product program placement in store location and check-out lane end cap for sales performance subject to a number of constraints, including, e.g., a total number of stores into which a program is to be placed, an end cap priority level assigned to a program, a store classification, and various other constraints that might be imposed by retailers depending on various business considerations. In the foregoing manner, components of computing device 200 may function individually as well in combination to improve sales performance and profitability by optimizing check-out lane end cap placement of various product programs.

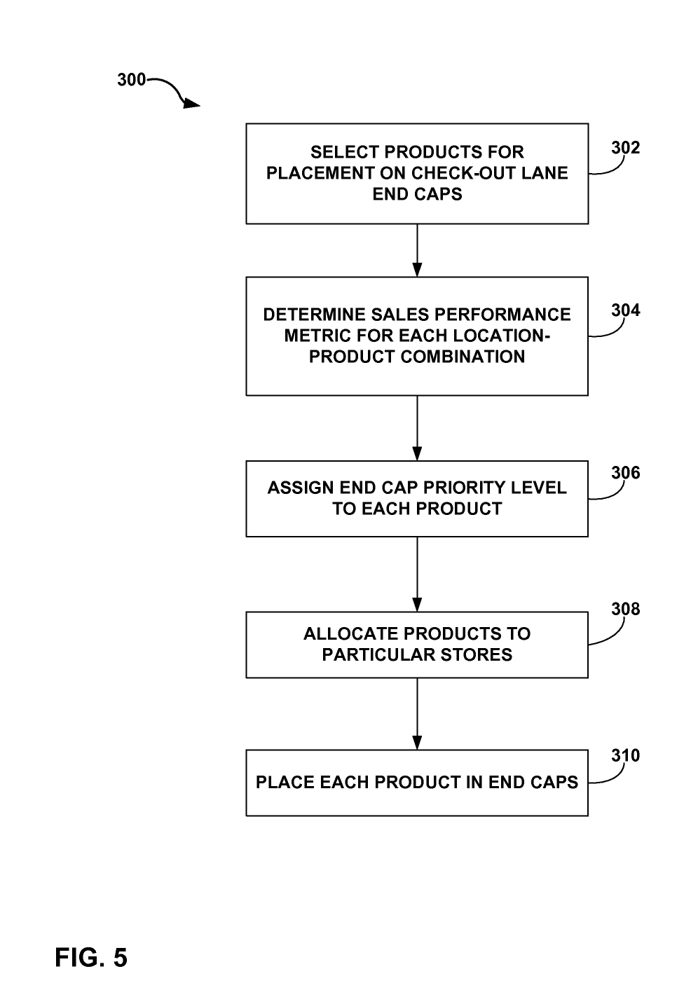

FIG. 5 is a flowchart illustrating an example process 300 that a computing device may perform to implement end cap optimization, in accordance with one or more aspects of this disclosure. While process 300 may be performed by any device or combination of devices capable of implementing the techniques of this disclosure, process 300 is described herein with reference to computing device 200 of FIG. 4, for ease of discussion purposes only.

Process 300 may begin when program selection module 218 selects products for placement on check-out lane end caps in a number of store locations (step 302). As discussed, the selected products may each be part of a program. Each program, in turn, may comprise a single product, or various combinations of multiple products. As discussed, the selected products may form an “eligible pool” of products for end cap placement, and program selection module 218 may select the eligible pool from a larger superset of products considered for end cap placement.

Additionally, sales analysis module 220 may determine a sales performance metric for each location-product combination based on past sales data for the products and locations (step 304). More specifically, sales analysis module 220 may analyze sales performance data for each product of the eligible pool in relation to each retail store location served by a retail chain implementing process 300. In examples, sales analysis module 220 may obtain and process top line data associated with each product at each store location during a corresponding season of one or more past years. In some examples, during a current Holiday season, sales analysis module 220 may obtain and process top line data for greeting cards sold at each of store locations 100 illustrated in FIG. 1. In one such example, the processed top line data may correspond to Holiday seasons of each of 5 years prior to the current year. In another such example, the processed top line data may correspond to alternating years of a previous 10 year span.

Based on the past sales data obtained and processed for each location-product combination, sales analysis module 220 may generate a sales performance metric for each location-product combination. Sales analysis module 220 may generate the sales performance metric by processing the obtained top line data in a variety of ways. Examples of such processing may include one or more of determining a percentage of the store location's total sales attributed to the product, consistency of sales of the product over several prior years (during the corresponding season), comparative sales of the product against other products/programs selected for end cap placement in prior years, etc.

Further, program priority module 228 may assign an end cap priority level to each product of the eligible pool (step 306). As discussed, program priority module 228 may determine the end cap priority levels based on various criteria, such as bottom line information, cost price, volume of a product to be supplied, comparative top line data with other products of the eligible pool, etc. As also discussed, program priority module 228 may assign equal priority levels to different products, but delineate the products by adding a distinct store classification to the priority level of each such product. In examples, the assigned priority level may indicate on which end cap the product is to be placed. For example, a priority level of ‘9’ may indicate that a product is to be placed on a ninth end cap of those store locations that have at least 9 check-out lane end caps. Similarly, a priority level of ‘2A’ may indicate that a product is to be placed on a second end cap of those store locations placed in the ‘A’ category of stores.

Store selection module 222 may allocate products of the eligible pool to particular stores (step 308). In various examples, store selection module 222 may allocate a product to a particular store, or set of stores, based on factors such as in-store historical sales data of the products for the store locations, catalogued demographic data of consumers who frequent each store location, ease with which inventory of the product can be replenished at a store location, and others. In some implementations, store selection module 222 may assign store classifications, based on which program priority module 228 may delineate products that are assigned the same end cap priority level. In allocating products to particular stores, store selection module 222 may also utilize data output by other components of computing device 200, such as sales analysis module 220 and others.

A user of computing device 200, such as a retail chain or administrator thereof, may ship, dispatch, or deploy each product of the eligible pool to various store locations for placement on specific end caps, based on the respective priority levels and the allocation of the programs to particular store locations. In various implementations, one or more of program priority module 228, store selection module 222, and applications 216 may aid in the step of shipping or otherwise transporting the product programs to the store locations for check-out lane end cap placement. In other implementations, computing device 200 may include a dedicated component (e.g., a deployment or dispatch module, not shown for ease of illustration purposes only) that may enable the retain to chain to more easily ship the products to the store locations for check-out lane end cap placement. The retail chain may use computing device 200 to discern priority levels assigned to product programs, store classifications, and other pertinent information in the process of implementing the program end cap placements generated by computing device 200.

Techniques described herein may be implemented, at least in part, in hardware, software, firmware, or any combination thereof. For example, various aspects of the described embodiments may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described herein. In addition, any of the described units, modules or components may be implemented together or separately as discrete but interoperable logic devices. Depiction of different features as modules or units is intended to highlight different functional aspects and does not necessarily imply that such modules or units are realized by separate hardware, firmware, or software components. Rather, functionality associated with one or more modules or units may be performed by separate hardware, firmware, or software components, or integrated within common or separate hardware, firmware, or software components.

Techniques described herein may also be embodied or encoded in an article of manufacture including a computer-readable storage medium and/or a computer-readable storage device encoded with instructions. Instructions embedded or encoded in an article of manufacture including an encoded computer-readable storage device, may cause one or more programmable processors, or other processors, to implement one or more of the techniques described herein, such as when instructions included or encoded in the computer-readable storage device are executed by the one or more processors. Computer-readable storage media and/or computer readable storage devices may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. Additional examples of computer readable medium include computer-readable storage devices, computer-readable memory, and tangible computer-readable medium, in some examples, an article of manufacture may comprise one or more computer-readable storage media,

In some examples, computer-readable storage media may comprise non-transitory media. The term “non-transitory” may indicate that the storage medium is tangible and is not embodied in a carrier wave or a propagated signal in certain examples, a non-transitory storage medium may store data that can, over time, change (e.g., in RAM or cache).

Various examples have been described. These and other examples are within the scope of the following claims.

1. A method comprising:
selecting a plurality of products from a larger plurality of products, the selected plurality of products being a subset of the larger plurality of products, and the selected plurality of products to be placed in a plurality of check-out lane end caps in a plurality of stores based at least in part on historical sales data for each of the plurality of products across all of the plurality of stores, wherein each of the plurality of check-out lane end caps comprises a fixture configured to hold and display one or more products for sale in a store;
receiving a total number of stores into which each of the selected products is to be placed in at least one check-out lane end cap;
receiving at least one bid associated with a product of the larger plurality of products, wherein the at least one bid comprises a request to place the product in at least one of the plurality of check-out lane end caps, and at least one of a cost price of an inventory of the product an inventory amount of the product a turnaround time associated with replenishing inventory of the product, and a total number of stores into which the product is to be placed;
determining, with a computing device, a sales performance metric for each of the selected products based at least in part on in-store historical sales data representative of sales of the product in each of the plurality of stores; and
determining, with the computing device, which of the plurality of stores to place each of the selected products in a check-out lane end cap of that store based at least in part on the received total number of stores into which the product is to be placed, the received bid, and the determined sales performance metric for the product.

2. The method of claim 1, wherein each of the plurality of check-out lane end caps in each of the plurality of stores comprises a level of priority selected from a plurality of levels of priority in a predetermined order, the method further comprising:
assigning each of the selected products a priority level that corresponds to one of the plurality of levels of priority of the check-out lane end caps; and
determining, with the computing device, which of the plurality of stores to place each of the selected products in a check-out lane end cap of that store based at least in part on the received total number of stores into which the product is to be placed, the determined sales performance metric for the product, and the assigned priority level of the product.

3. The method of claim 2, wherein the plurality of stores is categorized into groups, wherein each group of stores is associated with a store classification, and further comprising:
assigning a first selected product of the selected products to a first store classification of the store classifications; and
allocating the first selected product to only those groups of stores that have the first store classification, and that include a check-out lane end cap with a level of priority that is equal to the priority level assigned to the first selected product.

4. The method of claim 3, further comprising:
assigning a second selected product of the selected products to a second store classification of the store classifications; and
allocating the second selected product to only those groups of stores that have the second store classification, and that include a check-out lane end cap with a level of priority that is equal to the priority level assigned to the second selected product,
wherein the priority level of the first selected product is equal to the priority level of the second selected product.

5-6. (canceled)

7. The method of claim 1, wherein each of the plurality of check-out lane end caps in each of the plurality of stores comprises a level of priority selected from a plurality of levels of priority in a predetermined order, and wherein the bid comprises a priority level for the product that corresponds to one of the plurality of levels of priority of the check-out lane end caps.

8. The method of claim 1, further comprising:
selecting a time period during which to place products in the plurality of check-out lane end caps in the plurality of stores,
wherein at least one of selecting the plurality of products to be placed in the plurality of check-out lane end caps and determining, with the computing device, which of the plurality of stores to place each product in a check-out lane end cap of that store is based at least in part on the selected time period.

9. The method of claim 1, further comprising:
designating one of the plurality of stores as a new store;
comparing at least one characteristic of the new store to a corresponding characteristic of one or more other stores of the plurality of stores;
based on the comparison, designating at least one of the one or more other stores as a model store for the new store; and
employing in-store historical sales data representative of sales of each of the plurality of products in the model store as in-store historical sales data representative of sales of each of the plurality of products in the new store.

10. The method of claim 1, further comprising:
normalizing the historical sales data for each of the plurality for each of the selected products across all of the plurality of stores, by at least one of scaling the historical sales data based on a sales volume associated with each of the plurality of stores, determining a percentage of total sales at each of the plurality of stores represented by the historical sales data of each of the selected products, and comparing the historical sales data of each of the selected products to a chain average associated with each of the selected products, wherein the chain average represents an average value of sales of each of the selected products across all of the plurality of stores.

11. The method of claim 1, wherein the selected products to be placed in the plurality of check-out lane end caps is a first plurality of products, and wherein selecting the first plurality of products to be placed in the plurality of check-out lane end caps further comprises:
identifying a second plurality of products larger than the first plurality of products, wherein the second plurality of products includes all products of the first plurality of products and at least one product not included in the first plurality of products, and wherein each product of the second plurality of products comprises a product categorized as an impulse purchase product; and
selecting the first plurality of products from the second plurality of products.

12. The method of claim 1, further comprising:
receiving a unit price for each of the selected plurality of products; and
determining, with the computing device, which of the plurality of stores to place each of the selected products in a check-out lane end cap of that store based at least in part on the received total number of stores into which the product is to be placed, the determined sales performance metric for the product, and the unit price for the product.

13. The method of claim 1, wherein the sales performance metric determined for each of the selected products comprises at least one of sales revenue, profit, or sales volume for each product.

14. A device comprising:
a memory; and
at least one programmable processor configured to execute one or more instructions stored to the memory to perform operations comprising:
selecting a plurality of products from a larger plurality of products, the selected plurality of products being a subset of the larger plurality of products, and the selected plurality of products to be placed in a plurality of check-out lane end caps in a plurality of stores based at least in part on historical sales data for each of the plurality of products across all of the plurality of stores, wherein each of the plurality of check-out lane end caps comprises a fixture configured to hold and display one or more products for sale in a store;
receiving a total number of stores into which each of the selected products is to be placed in at least one check-out lane end cap;
receiving at least one bid associated with a product of the larger plurality of products, wherein the at least one bid comprises a request to place the product in at least one of the plurality of check-out lane end caps, and at least one of a cost price of an inventory of the product, an inventory amount of the product, a turnaround time associated with replenishing inventory of the product, and a total number of stores into which the product is to be placed;
determining a sales performance metric for each of the selected products based at least in part on in-store historical sales data representative of sales of the product in each of the plurality of stores; and
determining which of the plurality of stores to place each of the selected products in a check-out lane end cap of that store based at least in part on the received total number of stores into which the product is to be placed, the received bid, and the determined sales performance metric for the product.

15. The device of claim 14, wherein each of the plurality of check-out lane end caps in each of the plurality of stores comprises a level of priority selected from a plurality of levels of priority in a predetermined order, and wherein the at least one programmable processor is configured to perform operations further comprising:
assigning each of the selected products a priority level that corresponds to one of the plurality of levels of priority of the check-out lane end caps; and
determining, with the computing device, which of the plurality of stores to place each of the selected products in a check-out lane end cap of that store based at least in part on the received total number of stores into which the product is to be placed, the determined sales performance metric for the product, and the assigned priority level of the product.

16. The device of claim 15, wherein the at least one programmable processor is configured to perform operations further comprising:
assigning a first selected product of the selected products to a first store classification of the store classifications; and
allocating the first selected product to only those groups of stores that have the first store classification, and that include a check-out lane end cap with a level of priority that is equal to the priority level assigned to the first selected product.

17. The device of claim 16, wherein the at least one programmable processor is configured to perform operations further comprising:
assigning a second selected product of the selected products to a second store classification of the store classifications; and
allocating the second selected product to only those groups of stores that have the second store classification, and that include a check-out lane end cap with a level of priority that is equal to the priority level assigned to the second selected product,
wherein the priority level of the first selected product is equal to the priority level of the second selected product.

18-19. (canceled)

20. The device of claim 14, wherein each of the plurality of check-out lane end caps in each of the plurality of stores comprises a level of priority selected from a plurality of levels of priority in a predetermined order, and wherein the bid comprises a priority level for the product that corresponds to one of the plurality of levels of priority of the check-out lane end caps.

21. The device of claim 14, wherein the at least one programmable processor is configured to perform operations further comprising:
selecting a time period during which to place products in the plurality of check-out lane end caps in the plurality of stores,
wherein at least one of selecting the plurality of products to be placed in the plurality of check-out lane end caps and determining, with the computing device, which of the plurality of stores to place each product in a check-out lane end cap of that store is based at least in part on the selected time period.

22. The device of claim 14, wherein the at least one programmable processor is configured to perform operations further comprising:
designating one of the plurality of stores as a new store;
comparing at least one characteristic of the new store to a corresponding characteristic of one or more other stores of the plurality of stores;
based on the comparison, designating at least one of the one or more other stores as a model store for the new store; and
employing in-store historical sales data representative of sales of each of the plurality of products in the model store as in-store historical sales data representative of sales of each of the plurality of products in the new store.

23. The device of claim 14, wherein the at least one programmable processor is configured to perform operations further comprising:
normalizing the historical sales data for each of the plurality for each of the selected products across all of the plurality of stores, by at least one of scaling the historical sales data based on a sales volume associated with each of the plurality of stores, determining a percentage of total sales at each of the plurality of stores represented by the historical sales data of each of the selected products, and comparing the historical sales data of each of the selected products to a chain average associated with each of the selected products, wherein the chain average represents an average value of sales of each of the selected products across all of the plurality of stores.

24. The device of claim 14, wherein the at least one programmable processor is configured to perform operations further comprising:
receiving a unit price for each of the selected plurality of products; and
determining, with the computing device, which of the plurality of stores to place each of the selected products in a check-out lane end cap of that store based at least in part on the received total number of stores into which the product is to be placed, the determined sales performance metric for the product, and the unit price for the product.

25. The device of claim 14, wherein the sales performance metric determined for each of the selected products comprises at least one of sales revenue, profit, or sales volume for each product.

26. A computer-readable storage device encoded with instructions that, when executed, cause one or more processors of a computing device to:
select a plurality of products from a larger plurality of products, the selected plurality of products being a subset of the larger plurality of products, and the selected plurality of products to be placed in a plurality of check-out lane end caps in a plurality of stores based at least in part on historical sales data for each of the plurality of products across all of the plurality of stores, wherein each of the plurality of check-out lane end caps comprises a fixture configured to hold and display one or more products for sale in a store;
receive a total number of stores into which each of the selected products is to be placed in at least one check-out lane end cap;
receive at least one bid associated with a product of the larger plurality of products, wherein the at least one bid comprises a request to place the product in at least one of the plurality of check-out lane end caps, and at least one of a cost price of an inventory of the product an inventory amount of the product, a turnaround time associated with replenishing inventory of the product, and a total number of stores into which the product is to be placed;
determine a sales performance metric for each of the selected products based at least in part on in-store historical sales data representative of sales of the product in each of the plurality of stores; and
determine which of the plurality of stores to place each of the selected products in a check-out lane end cap of that store based at least in part on the received total number of stores into which the product is to be placed, the received bid, and the determined sales performance metric for the product.
